(19) United States
(12) Patent Application Publication
(10) Pub. No.: US 2019/0047201 A1
(43) Pub. Date: Feb. 14, 2019

(54) A METHOD OF EXTRUDING A THERMOPLASTIC POLYMER OF A DESIRED COLOR AND AN APPARATUS FOR PERFORMING THE METHOD

(71) Applicants: Russell Neuman, Rocky Face, GA (US); Peter Pförtner, Rocky Face, GA (US)

(72) Inventors: Russell Neuman, Rocky Face, GA (US); Peter Pförtner, Rocky Face, GA (US)

(21) Appl. No.: 15/673,836

(22) Filed: Aug. 10, 2017

(51) Int. Cl. B29C 47/92; B29C 47/10

(52) U.S. Cl. CPC B29C 47/92; B29C 47/1009; B29C 47/1027; B29K 2995/002; B29C 2947/926; B29C 2947/92447; B29C 2947/92257

(57) ABSTRACT

The present invention comprises a method. The method comprises selectively feeding color masterbatch thermoplastic polymer pellets or granules to an extruder from a first gravimetric feeder operatively connected to a computing device and adapted to receive signals from the computing device to control the amount of the color masterbatch thermoplastic polymer pellets or granules dispensed therefrom and feeding non-colored thermoplastic polymer pellets or granules to the extruder from a second gravimetric feeder operatively connected to the computing device and adapted to receive signals from the computing device to control the amount of non-colored polymer pellets or granules dispensed therefrom. The method further comprises wherein the computing device is adapted to send signals to the first and second gravimetric feeders to separately adjust the rates at which the first and second gravimetric feeders each feed the color masterbatch thermoplastic polymer pellets or granules and the non-colored thermoplastic polymer pellets or granules to the extruder; wherein the second gravimetric feeders is sent signals to continuously feed the non-colored thermoplastic polymer pellets or granules to the extruder at a desired rate; and wherein the first gravimetric feeder is randomly sent signals to feed the color masterbatch thermoplastic polymer pellets or granules to the extruder at a first rate and randomly sent signals to feed the color masterbatch thermoplastic polymer pellets or granules to the extruder at a second rate that is different from the first rate.

### FIELD OF THE INVENTION

The present invention generally relates to extruded polymers having a desired color and/or properties. More particularly, the present invention relates to a method for coloring polymers immediately before extrusion. The present invention also relates to a method of extruding polymer strands, monofilaments, ribbons, fibers, filaments, yarns, sheets or films of a desired color. The present invention also relates to a method of delustering an extrudate. The present invention further relates to a method of fireproofing an extrudate.

### BACKGROUND OF THE INVENTION

Thermoplastic polymers are extruded into strands, monofilaments, ribbons, fibers, filaments, yarns, sheets or films for many different applications. For example, thermoplastic polymers are extruded into fibers for making yarns for textiles, carpets and many other applications. Extruded thermoplastic polymers are frequently colored during the extrusion process to produce strands, monofilaments, ribbons, fibers, filaments, yarns, sheets or films of a desired color. The process for coloring extruded thermoplastic polymers with a color masterbatch or color compound is well known in the art. The following is a brief description of one of many prior art process 100.

A powdered pigment 102 and a powdered, uncolored thermoplastic polymer 104 and any desired additives are introduced into a blender 106 and thoroughly blended to insured uniform distribution of the pigment in the polymer. The blended thermoplastic polymer and pigment are extruded 108 into strands and the strands are chopped into relatively small single pigment dispersion (“SPD”) pellets 110.

To make a color masterbatch, two or more different color single pigment dispersion pellets 112, such as SPD1, SPD2, etc., and uncolored, thermoplastic polymer pellets 114 are weighed out in a specific proportion and added in bulk into a blender 116 and thoroughly blended to insured uniform distribution of the single pigment dispersion pellets and the thermoplastic polymer pellets. Any desired additives are also added to the blender 116. The blend is then fed into an extruder 118, which melts and mixes or homogenizes the polymer with the desired color. The extrudate is then pelletized by means of strand pelletization, under water pelletizing or other means of creating cylindrical or spherical thermoplastic polymer pellets or granules, which comprise a color masterbatch 120. These masterbatch pellets have a concentrated custom color. The color masterbatch pellets can comprise about 0.5% to about 90% by weight pigment, but more conventionally comprise about 40% to about 65% by weight pigment. The color masterbatch pellets typically have a size of about 1 mm to about 5 mm, but more conventionally about 2 mm to about 3 mm. The color masterbatch pellets are typically stored in boxes, barrels or bags for later use by and or shipment to a producer of colored extruded thermoplastic items, such as a fiber, film or sheet.

To produce an extruded item of a desired color, such as a fiber, the color masterbatch pellets 122 are weighed out and introduced in bulk into a blender 124. Uncolored polymer pellets 126 are weighed out and added in bulk to the blender 124. The contents of the blender 124 are then thoroughly blended to form a uniform mixture. The mixture is then fed to an extruder 126, which extrudes the mixture into a fiber 128, which can then be further processed into a yarn. The fiber 128 has a desired color and shade. Another method is to use a volumetric feeder or for higher precision, a gravimetric feeder, to add the desired level of the colorant to the base resin directly at the extruder.

Any variation in weighing, mixing or feeding the color masterbatch to the extruder will result in color and/or strength variation visible in the final product. This effect can be very pronounced in applications, such as synthetic turf or tufted carpet, where a yarn is unwound from a cone and tufted into a single row of many tufts into a carpet. To mitigate this problem, the industry is using various approaches to create a heathered look, such as twisting different color yarns into a single yarn, blending different color fibers for a nonwoven fabric or using two or three colored monofilaments or slit tapes for a synthetic turf application. However, producing a heathered yarn is much more costly than using a single color yarn.

In order to make colored items of different colors, color masterbatch pellets for each custom color must be inventoried. For companies making a relatively large number of items of different colors, such as fibers for textiles, a relatively large number of different color masterbatch pellets must be maintained, which is expensive both in terms of the cost of the pellets themselves, but also in terms of warehouse space to inventory those pellets.

There is also a significant problem with color master batch pellets not being uniformly blended with colorless polymer pellets. This problem results in streaking of the color and non-uniformity of the color of extruded items, such as fibers, films, sheets and the like.

It is also costly to produce special effects in extruded items such as delustering. Producing fire retardant extruded items is also a relatively costly process.

It would be desirable to be able to prepare extruded items, such as strands, monofilaments, ribbons, fibers, filaments, yarns, films or sheets of a desired color in a more economical manner and to avoid streaks or lines of non-uniform color in the extrudate. It would also be desirable to economically produce extruded items having a heathered appearance. Further, it would be desirable to be able to produce delustered extruded items and fire retardant extruded items in a more economical manner.

### SUMMARY OF THE INVENTION

In one disclosed embodiment, the present invention comprises a method. The method comprises feeding first single pigment dispersion thermoplastic polymer pellets or granules to an extruder from a first gravimetric feeder operatively connected to a computing device and adapted to receive signals from the computing device to control the amount of the first single pigment dispersion thermoplastic polymer pellets or granules dispensed therefrom; feeding second single pigment dispersion thermoplastic polymer pellets or granules to the extruder from a second gravimetric feeder operatively connected to the computing device and adapted to receive signals from the computing device to control the amount of the second single pigment dispersion thermoplastic polymer pellets or granules dispensed therefrom; and feeding non-colored thermoplastic polymer pellets or granules to the extruder from a third gravimetric feeder operatively connected to the computing device and adapted to receive signals from the computing device to control the amount of non-colored thermoplastic polymer pellets or granules dispensed therefrom. The method also comprises measuring the color of the extruded polymer using a photo colorimeter operatively connected to the computing device and adapted to send signals to the computing device corresponding to the color of the extruded polymer; wherein the computing device is adapted to receive signals from the photo colorimeter corresponding to the color of the extruded polymer and includes program instructions for comparing the measured color of the extruded polymer to a desired color of the extruded polymer and determine a difference therebetween; and wherein the computing device is adapted to send signals to the first, second and third gravimetric feeders to separately adjust the rates at which the first, second and third gravimetric feeders each feed the first single pigment dispersion thermoplastic polymer pellets or granules, the second single pigment dispersion thermoplastic polymer pellets or granules and the non-colored thermoplastic polymer pellets or granules to the extruder in response to the difference between the measured color of the extruded polymer and the desired color of the extruded polymer.

In another disclosed embodiment, the present invention comprises a method. The method comprises feeding color masterbatch thermoplastic polymer pellets or granules to an extruder from a first gravimetric feeder operatively connected to a computing device and adapted to receive signals from the computing device to control the amount of the color masterbatch thermoplastic polymer pellets or granules dispensed therefrom; selectively feeding first single pigment dispersion thermoplastic polymer pellets or granules to the extruder from a second gravimetric feeder operatively connected to the computing device and adapted to receive signals from the computing device to control the amount of the single pigment dispersion thermoplastic polymer pellets or granules dispensed therefrom; selectively feeding second single pigment dispersion thermoplastic polymer pellets or granules to the extruder from a third gravimetric feeder operatively connected to the computing device and adapted to receive signals from the computing device to control the amount of the second single pigment dispersion thermoplastic polymer pellets or granules dispensed therefrom; and feeding non-colored thermoplastic polymer pellets or granules to the extruder from a fourth gravimetric feeder operatively connected to the computing device and adapted to receive signals from the computing device to control the amount of non-colored thermoplastic polymer pellets or granules dispensed therefrom. The method also comprises wherein the computing device is adapted to send signals to the first, second, third and fourth gravimetric feeders to separately adjust the rates at which the first, second, third and fourth gravimetric feeders each feed the color masterbatch thermoplastic polymer pellets or granules, the first single pigment dispersion thermoplastic polymer pellets or granules, the second single pigment dispersion thermoplastic polymer pellets or granules and the non-colored thermoplastic polymer pellets or granules to the extruder; wherein the first and fourth gravimetric feeders are sent signals to continuously feed the color masterbatch thermoplastic polymer pellets or granules and the non-colored thermoplastic polymer pellets or granules to the extruder; wherein in second gravimetric feeder is randomly sent signals to feed the first single pigment dispersion thermoplastic polymer pellets or granules to the extruder and the third gravimetric feeder is sent signals to not feed any second single pigment dispersion thermoplastic polymer pellets or granules to the extruder; and wherein in third gravimetric feeder is randomly sent signals to feed the second single pigment dispersion thermoplastic polymer pellets or granules to the extruder and the first gravimetric feeder is sent signals to not feed any first single pigment dispersion thermoplastic polymer pellets or granules to the extruder.

In another disclosed embodiment, the present invention comprises a method. The method comprises selectively feeding color masterbatch thermoplastic polymer pellets or granules to an extruder from a first gravimetric feeder operatively connected to a computing device and adapted to receive signals from the computing device to control the amount of the color masterbatch thermoplastic polymer pellets or granules dispensed therefrom; and feeding non-colored thermoplastic polymer pellets or granules to the extruder from a second gravimetric feeder operatively connected to the computing device and adapted to receive signals from the computing device to control the amount of non-colored thermoplastic polymer pellets or granules dispensed therefrom. The method also comprises wherein the computing device is adapted to send signals to the first and second gravimetric feeders to separately adjust the rates at which the first and second gravimetric feeders each feed the color masterbatch thermoplastic polymer pellets or granules and the non-colored thermoplastic polymer pellets or granules to the extruder; wherein the second gravimetric feeders is sent signals to continuously feed the non-colored polymer pellets to the extruder; and wherein the first gravimetric feeder is randomly sent signals to feed the color masterbatch thermoplastic polymer pellets or granules to the extruder and randomly sent signals to not feed the color masterbatch to the extruder.

In still another disclosed embodiment, the present invention comprises a method. The method comprises selectively feeding color masterbatch thermoplastic polymer pellets or granules to an extruder from a first gravimetric feeder operatively connected to a computing device and adapted to receive signals from the computing device to control the amount of the color masterbatch thermoplastic polymer pellets or granules dispensed therefrom and feeding non-colored thermoplastic polymer pellets or granules to the extruder from a second gravimetric feeder operatively connected to the computing device and adapted to receive signals from the computing device to control the amount of non-colored thermoplastic polymer pellets or granules dispensed therefrom. The method also comprises wherein the computing device is adapted to send signals to the first and second gravimetric feeders to separately adjust the rates at which the first and second gravimetric feeders each feed the color masterbatch thermoplastic polymer pellets or granules and the non-colored thermoplastic polymer pellets or granules to the extruder; wherein the second gravimetric feeders is sent signals to continuously feed the non-colored thermoplastic polymer pellets or granules to the extruder at a desired rate; and wherein the first gravimetric feeder is randomly sent signals to feed the color masterbatch thermoplastic polymer pellets or granules to the extruder at a first rate and randomly sent signals to feed the color masterbatch thermoplastic polymer pellets or granules to the extruder at a second rate that is different from the first rate.

In another disclosed embodiment, the present invention comprises a method. The method comprises feeding thermoplastic polymer pellets or granules having one or more color pigments dispersed therein to an extruder from a first gravimetric feeder operatively connected to a computing device and adapted to receive signals from the computing device to control the amount of the thermoplastic polymer pellets or granules having one or more color pigments dispersed therein dispensed therefrom, feeding non-colored thermoplastic polymer pellets or granules to the extruder from a second gravimetric feeder operatively connected to the computing device and adapted to receive signals from the computing device to control the amount of non-colored thermoplastic polymer pellets or granules dispensed therefrom and feeding thermoplastic polymer pellets or granules having titanium dioxide dispersed therein to an extruder from a third gravimetric feeder operatively connected to a computing device and adapted to receive signals from the computing device to control the amount of the thermoplastic polymer pellets or granules having titanium dioxide dispersed therein dispensed therefrom. The method also comprises wherein the computing device is adapted to send signals to the first and second gravimetric feeders to separately adjust the rates at which the first and second gravimetric feeders each feed the thermoplastic polymer pellets or granules having one or more color pigments dispersed therein and the non-colored thermoplastic polymer pellets or granules to the extruder and wherein the computing device is adapted to send signals to the third gravimetric feeder to adjust the rate at which the third gravimetric feeder feeds the thermoplastic polymer pellets or granules having titanium dioxide dispersed therein to the extruder such that an extrudate from the extruder contains sufficient titanium dioxide to deluster the extrudate from the extruder.

In another disclosed embodiment, the present invention comprises a method. The method comprises feeding thermoplastic polymer pellets or granules having one or more color pigments dispersed therein to an extruder from a first gravimetric feeder operatively connected to a computing device and adapted to receive signals from the computing device to control the amount of the thermoplastic polymer pellets or granules having one or more color pigments dispersed therein dispensed therefrom, feeding non-colored thermoplastic polymer pellets or granules to the extruder from a second gravimetric feeder operatively connected to the computing device and adapted to receive signals from the computing device to control the amount of non-colored thermoplastic polymer pellets or granules dispensed therefrom and selectively feeding thermoplastic polymer pellets or granules having a fire retardant composition dispersed therein to an extruder from a third gravimetric feeder operatively connected to a computing device and adapted to receive signals from the computing device to control the amount of the thermoplastic polymer pellets or granules having a fire retardant composition dispersed therein dispensed therefrom. The method also includes wherein the computing device is adapted to send signals to the first and second gravimetric feeders to separately adjust the rates at which the first and second gravimetric feeders each feed the thermoplastic polymer pellets or granules having one or more color pigments dispersed therein and the non-colored thermoplastic polymer pellets or granules to the extruder, wherein the computing device is adapted to send signals to the third gravimetric feeder to separately adjust the rates at which the third gravimetric feeder feeds the thermoplastic polymer pellets or granules having a fire retardant composition dispersed therein to the extruder and wherein the third gravimetric feeder is periodically sent signals to feed the thermoplastic polymer pellets or granules having a fire retardant composition dispersed therein to the extruder and randomly sent signals to not feed the thermoplastic polymer pellets or granules having a fire retardant composition dispersed therein to the extruder.

Accordingly, it is an object of the present invention to provide an improved system for producing an extruded color thermoplastic items, such as strands, monofilaments, ribbons, fibers, filaments, yarns, films or sheets.

Another object of the present invention is to provide a system for color blending, controlling and adjusting inline the color, shade and/or color saturation of a colored thermoplastic extrudate.

A further object of the present invention is to provide a system for producing a colored thermoplastic extrudate to create controlled amounts of color, shade and/or color saturation variation randomness to improve the visual appearance of the extrudate.

Another object of the present invention is to provide a system for providing a thermoplastic extrudate having a heathered appearance.

Yet another object of the present invention is to provide a system for providing a thermoplastic extrudate having a variegated or camouflage appearance.

Another object of the present invention is to provide a system of providing an extruded custom color item in a more economical manner.

Another object of the present invention is to provide a system of providing a delustered extruded color item.

A further object of the present invention is to provide a system of more economically providing a fire retardant extruded color item.

These and other objects, features and advantages of the present invention will become apparent after a review of the following detailed description of the disclosed embodiments and the appended drawing and claims.

### BRIEF DESCRIPTION OF THE DRAWINGS

FIG. 1 is a schematic drawing of a prior art process for producing extruded custom colored items.

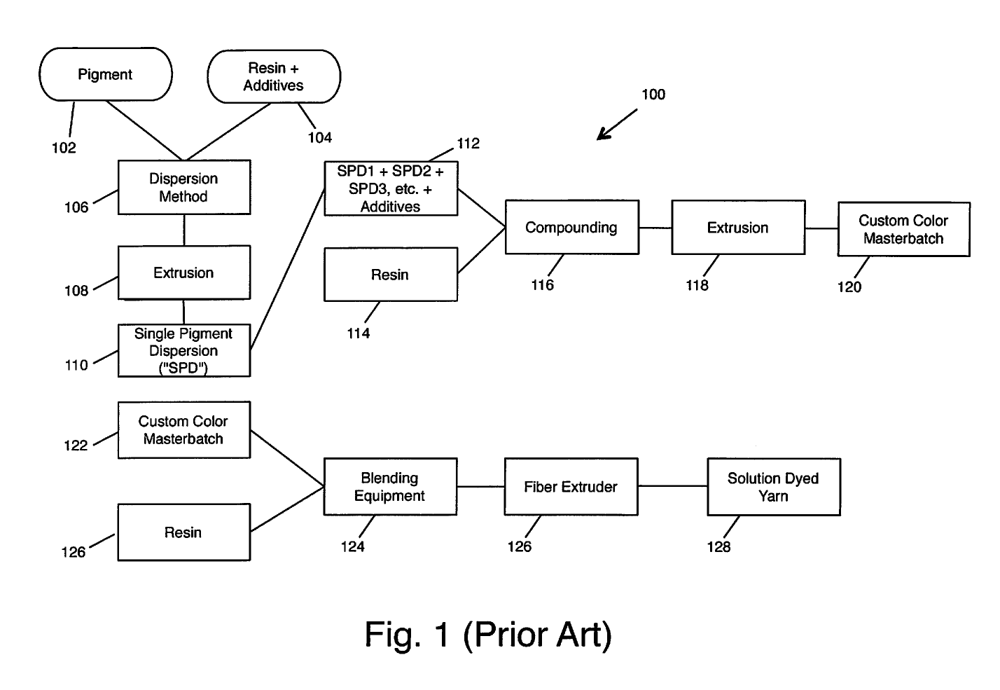

FIG. 2 is a schematic top plan view of a disclosed embodiment of a gravimetric feeder in accordance with the present invention.

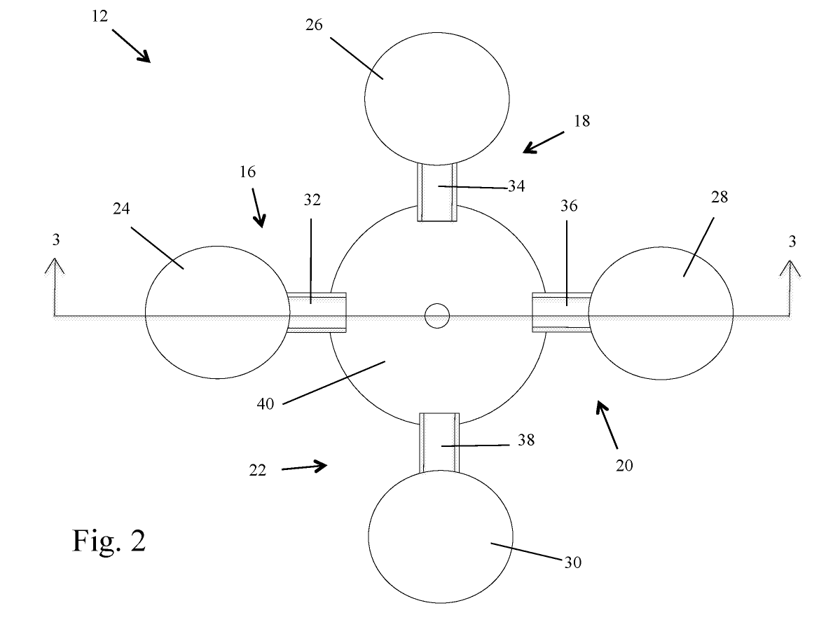

FIG. 3 is a schematic cross-sectional view taken along the line 3-3 of the gravimetric feeder shown in FIG. 2.

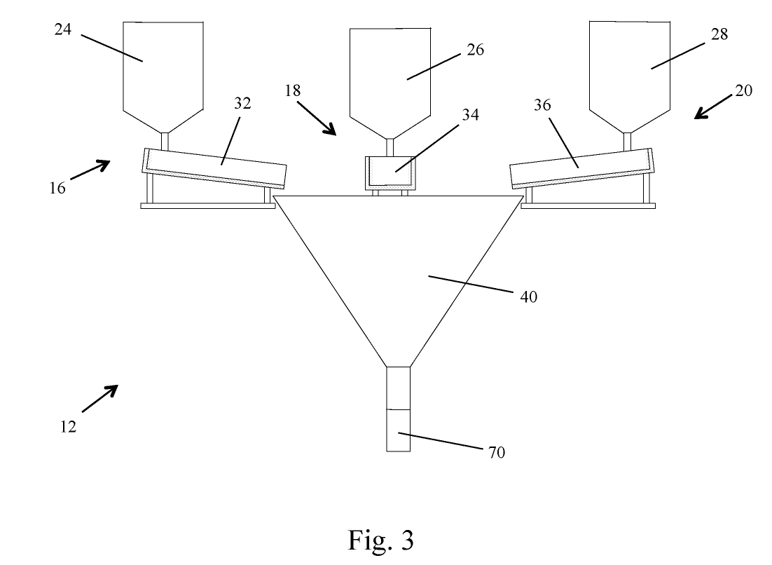

FIG. 4 is a schematic view of a disclosed embodiment of a system for extruding colored thermoplastic items in accordance with the present invention.

### DETAILED DESCRIPTION OF THE DISCLOSED EMBODIMENTS

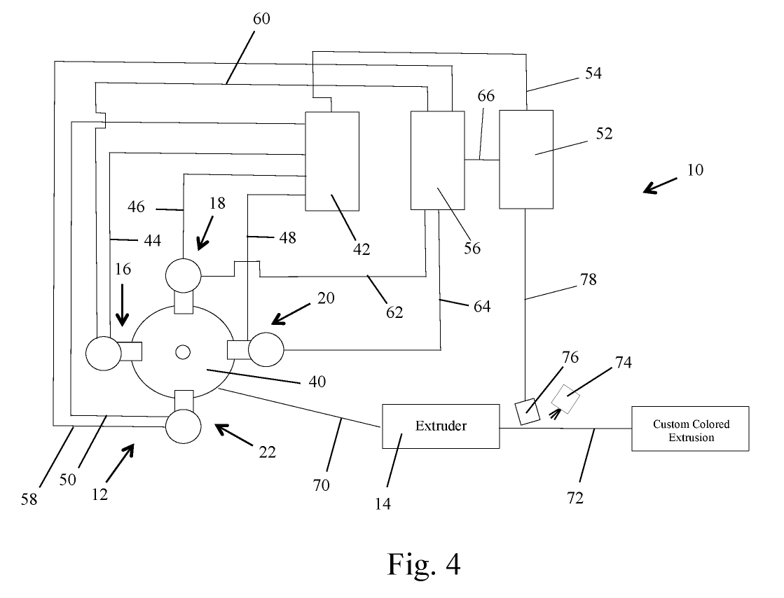

In a disclosed embodiment, the present invention comprises a system for producing extruded custom color thermoplastic items, such as strands, monofilaments, ribbons, fibers, filaments, yarns, films or sheets. Referring now to the drawing in which like numbers indicate like elements throughout the several views, there is shown in FIG. 4 a disclosed embodiment of a custom color extrusion system 10 for producing custom color extruded thermoplastic items in accordance with the present invention. The custom color extrusion system 10 comprises a precision feeding device 12 and a thermoplastic extruder 14. The precision feeding device 12 comprises a plurality of precision gravimetric feeders, such as a first gravimetric feeder 16, a second gravimetric feeder 18, a third gravimetric feeder 20 and a fourth gravimetric feeder 22. Precision gravimetric feeders are known in the art and are commercially available under the designation SL Gravimetric Feeder Blender from Advanced Blending Solutions Inc., Wallace, Mich. or ColorSave-Micro from LIAD Weighing and Control Systems Ltd., Misgav, Israel. Since precision gravimetric feeding devices are known, they are only shown schematically in the present application and their major components are described.

Each of the four precision gravimetric feeders 16-22 comprises a first hopper 24, a second hopper 26, a third hopper 28 and a fourth hopper 30, respectively. The hoppers 24-30 are positioned above a first trough 32, a second through 34, a third trough 36 and a fourth trough 38, respectively. Each of the troughs 32-38 is mounted so that the end of the trough under the hoppers 24-30 is disposed higher than the opposite end of the trough. Each of the troughs 32-38 is disposed radially around the periphery of a circular-shaped funnel 40 so that the lower end of each of the troughs; i.e., the end opposite the hoppers 24-30, is disposed over the edge of the funnel. Therefore, each of the troughs 32-38 is slanted from the end under the hoppers 24-30 toward the funnel 40. Each of the troughs 32-38 is attached to a variable speed vibrator (not shown) so that the vibrator vibrates the trough. Each of the hoppers 24-30 is adapted to receive and contain a plurality of thermoplastic polymer pellets (not shown) and to dispense the thermoplastic polymer pellets onto the upper end of each of the troughs 32-38. When thermoplastic polymer pellets (not shown) are dispensed from the hoppers 24-30 and the vibrators (not shown) vibrate the troughs 32-38, the pellets are transported down the slanted troughs and fall off the ends of the troughs into the funnel 40. By varying the speed of the vibrations (i.e., varying the frequency of the vibrations), the speed that the thermoplastic polymer pellets traveling down the troughs can be variably controlled. Thus, the higher the frequency of the vibrations of the troughs 32-38, the faster the thermoplastic polymer pellets travel down the troughs. Therefore, the rate of delivery of thermoplastic polymer pellets from the each of the troughs 32-38 to the funnel 40 can be separately controlled by adjusting the frequency of the vibrations of each of the troughs.

Each of the troughs 32-38 is mounted on a plurality of load cells (not shown). The load cells continuously weight each of the troughs 32-38, each of the associated hoppers 24-30 and the contents thereof. As thermoplastic polymer pellets are dispensed from each trough 32-38 into the funnel 40, the weight of each trough, each of the associated hoppers 24-30 and the contents thereof is reduced by an amount equal to the weight of the thermoplastic polymer pellets dispensed by each trough. Therefore, the load cells, in effect, continuously weigh the amount of thermoplastic polymer pellets dispensed by each of the troughs 32-38 by measuring the weight loss of each trough 32-38, each of the associated hoppers 24-30 and the contents thereof.

The load cells (not shown) for each of the gravimetric feeders 16-22 are connected to a digital controller 42 by an electric circuit; i.e., the load cells (not shown) of the gravimetric feeder 16 are connected to the controller 42 by an electric circuit, such as by wires 44; the load cells (not shown) of the gravimetric feeder 18 are connected to the controller 42 by an electric circuit, such as by wires 46; the load cells (not shown) of the gravimetric feeder 20 are connected to the controller 42 by an electric circuit, such as by wires 48 and the load cells (not shown) of the gravimetric feeder 22 are connected to the controller 42 by an electric circuit, such as by wires 50. The digital controller 42 is adapted to receive signals from the load cells (not shown) associated with each of the gravimetric feeders 16-22 and convert those signals into a weight for each of the troughs 32-38, each of the associated hoppers 24-30 and the contents thereof. The digital controller 42 is also adapted to send signals to a computing device 52 corresponding to the weights of each of the troughs 32-38, each of the associated hoppers 24-30 and the contents thereof. The digital controller 42 is connected to the computing device 52 by an electric circuit, such as by the wires 54.

The vibrators (not shown) for each of the gravimetric feeders 16-22 are connected to a digital controller 56 by an electric circuit; i.e., the vibrator (not shown) of the gravimetric feeder 16 is connected to the controller 56 by an electric circuit, such as by wires 58; the vibrator (not shown) of the gravimetric feeder 18 is connected to the controller 56 by an electric circuit, such as by wires 60; the vibrator (not shown) of the gravimetric feeder 20 is connected to the controller 56 by an electric circuit, such as by wires 62 and the vibrator (not shown) of the gravimetric feeder 22 is connected to the controller 56 by an electric circuit, such as by wires 64. The digital controller 56 is adapted to send signals to each of the vibrators (not shown) associated with each of the gravimetric feeders 16-22 and to cause each vibrator to vibrate at a desired frequency. The digital controller 56 is also adapted to receive signals from the computing device 52 corresponding to a desired vibration frequency for each of the vibrators (not shown). The digital controller 56 is connected to the computing device 52 by an electric circuit, such as by wires 66.

The computing device 52 is adapted to receive signals from the controller 42 corresponding to the weight of each of the troughs 32-38, each of the associated hoppers 24-30 and the contents thereof. The computing device 52 is adapted to send signals to the controller 56 corresponding to a desired vibration frequency for each of the vibrators (not shown) associated with each of the troughs 32-38. The computing device 52 contains program instructions that allow a user to set each of the gravimetric feeders 16-22 to deliver a desired rate of thermoplastic polymer pellets; i.e., weight of pellets per unit time to the funnel 40. Thus, the gravimetric feeder 16 can be set to deliver a first rate of first thermoplastic polymer particles, the gravimetric feeder 18 can be set to deliver a second rate of second thermoplastic polymer particles, the gravimetric feeder 20 can be set to deliver a third rate of third thermoplastic polymer particles and the gravimetric feeder 22 can be set to deliver a fourth rate of fourth thermoplastic polymer particles.

The funnel 40 is connected to one end of a pipe or hose 70 and the other end of the hose is connected to the input throat of the extruder 14. Thus, thermoplastic particles (not shown) delivered to the funnel 40 by each of the gravimetric feeders 16-22 travel through the pipe 70 and into the extruder 14 where they are extruded in a manner well known in the art. The extruder 14 generally includes a plurality of heaters that gradually heat the thermoplastic polymer pellets (not shown) to their softening or melting point and a screw blends the thermoplastic polymer pellets and pushes the molten thermoplastic through a die, nozzle, orifice or slit at the end of the extruder to form the molten thermoplastic into a desired shape, such as a fiber 72, or other desired shapes such as strands, monofilaments, ribbons, filaments, yarns, sheets or films.

As seen in FIG. 4, when the extruded fiber 72 exits the extruder 14, a light source 74 of a constant, known color temperature is mounted adjacent the extruded fiber to illuminate it and a color photometer 76 is mounted to receive reflected light from the extruded fiber. The light from the light source 74 shines on the extruded fiber 72 and is reflected from the extruded fiber into the color photometer 76 where the color of the extruded fiber is detected. The color photometer 76 is connected to the computing device 52 by an electric circuit, such as by wires 78. The color photometer 76 is adapted to send signals to the computing device 52 corresponding to the measured color of the extruded fiber 72. The computing device 52 is adapted to receive signals from the color photometer 76 corresponding to the measured color of the extruded fiber 72. The computing device 52 includes program instructions to compare the measured color of the extruded fiber 72 to a desired color previously entered into the computing device and to determine differences therebetween.

The custom color extrusion system 10 can be operated in several different novel modes of operation. Each of those modes of operation will now be described below.

The first mode of operation of the custom color extrusion system 10 produces a custom color extrusion with the use of single pigment dispersions without the use of a color masterbatch. For example, a first single pigment dispersion in polyethylene thermoplastic polymer pellets containing a nickel azo yellow (PY 105) pigment dispersed therein is loaded into the hopper 24 of the first gravimetric feeder 16. A second single pigment dispersion in polyethylene thermoplastic polymer pellets containing a zinc ferrite (PY 119) pigment dispersed therein is loaded into the hopper 26 of the second gravimetric feeder 18. A third single pigment dispersion in polyethylene thermoplastic polymer pellets containing a phthalo green (PG 7) pigments dispersed therein is loaded into the hopper 28 of the third gravimetric feeder 20. Non-colored, virgin polyethylene thermoplastic polymer pellets are loaded into the hopper 30 of the fourth gravimetric feeder 22. The computing device 52 is provided with input of an identification number or SKU number corresponding to a desired color from an input device (not shown), such as a bar code reader or a keyboard. The computing device 52 includes a database of feed rates of single pigment dispersions in order to produce desired colors. Thus, when a SKU number is entered into the computing device 52 program instructions contained in the computing device search the database to find the feed rates of single pigment dispersion thermoplastic polymer pellets and non-colored thermoplastic polymer pellets that correspond to the SKU number. The computing device 52 then uses those feed rates to send signals to the controller 56 to set the individual feed rates for each of the gravimetric feeders 16-22. For example, the vibrator (not shown) associated with the first gravimetric feeder 16 is sent signals from the computing device 52 via the controller 56 to deliver the nickel azo yellow single pigment dispersion thermoplastic polymer pellets at a first rate, the vibrator (not shown) associated with the second gravimetric feeder 18 is sent signals to deliver the zinc ferrite single pigment dispersion thermoplastic polymer pellets at a second rate, the vibrator (not shown) associated with the third gravimetric feeder 20 is sent signals to deliver the phthalo green single pigment dispersion thermoplastic polymer pellets at a third rate and the vibrator (not shown) associated with the fourth gravimetric feeder 22 is sent signals to deliver the non-colored thermoplastic polymer pellets at a fourth rate. The three different colored single pigment dispersion thermoplastic polymer pellets and the non-colored thermoplastic polymer pellets are delivered from the ends of the troughs 32-38 into the funnel 40. Feedback is provided to the computing device 52 by the load cells associate with each of the gravimetric feeders 16-22 to provide the actual weight of thermoplastic polymer pellets dispensed by each of the gravimetric feeders 16-22. The computing device 52 is provided with program instructions to compare the actual feed rates associated with each of the gravimetric feeders 16-22 with the desired feed rates associated with the desired color. If the computing device 52 detects any difference between the actual rate and the desired rate, the computing device sends signals to the vibrators associated with any of the gravimetric feeders 16-22 to adjust the vibrators to thereby cause the gravimetric feeders to adjust their rate of delivery of thermoplastic polymer pellets to match the desired rate. The three different colored single pigment dispersion thermoplastic polymer pellets and the non-colored thermoplastic polymer pellets that fall into the funnel 40 from the gravimetric feeders 16-22 fall into the tube 70 and from the tube into the throat of the extruder 14. The three different colored single pigment dispersion thermoplastic polymer pellets and the non-colored thermoplastic polymer pellets are melted, mixed and extruded by the extruder into the fiber 72. As the extruded fiber 72 exits the extruder 14, light from the light source 74 shines on the extruded fiber and is reflected into the color photometer 76 which measured the actual color of the extruded fiber. Signals are sent from the color photometer 76 to the computing device 52 corresponding to the measured color of the extruded fiber. The computing device 52 includes program instructions to compare the measured color of the extruded fiber and the desired color corresponding to the SKU number. The computing device 52 includes program instructions to determine what changes need to be made to the feed rates of the gravimetric feeders 16-22 in order to change the measured color of the extruded fiber to the desired color corresponding to the SKU number. Signals are then sent from the computing device 52 to the controller 56 to adjust the thermoplastic pellet delivery rates of the gravimetric feeders 16-22 in order to produce the desired color associated with the SKU number. This feedback loop causes the feed rates of each of the gravimetric feeders 16-22 to be continually and individually adjusted in order to achieve and maintain the measured color of the extruded fiber 72 to match the desired color associated with the SKU number.

While the first mode of operation of the custom color extrusion system 10 of the present invention has been described as including three different single pigment dispersion thermoplastic polymer pellets, it is specifically contemplated that more or fewer single pigment dispersion thermoplastic polymer pellets can be used depending on the desired color to be produced. As indicated above, the precision feeding device 12 can include more or less than the four gravimetric feeders 16-22 shown. Whatever the number of different single pigment dispersion thermoplastic polymer pellets that are used, each of the single pigment dispersion thermoplastic polymer pellets requires its own individually controllable gravimetric feeder so that the rate of deliver of each of the single pigment dispersion thermoplastic polymer pellets can be individually controlled.

A second mode of operation of the custom color extrusion system 10 produces a custom color extrusion with the use of a color masterbatch and single pigment dispersions to randomly adjust the color of the extrusion toward a first selected color, such as a first primary color and then randomly toward a second selected color, such as a second primary color. The random introduction of this color “noise” into the extruded fiber 72 produced by the extrusion system of the present invention results in a heathered look in, for example, a fabric or a tufted carpet made with such extruded fibers. The present invention provides a more economically solution than currently available in the prior art for the production of fabrics, tufted carpets, and the like having a heathered look.

The second mode of operation of the custom color extrusion system 10 produces a custom color extrusion having a heathered look with the use of a color masterbatch and at least one single pigment dispersions, preferably two different single pigment dispersions. For example, a color masterbatch in polyethylene thermoplastic polymer pellets preferably containing approximately 10% to approximately 80% by weight of a custom color pigment blend, such as grass green, is loaded into the hopper 24 of the first gravimetric feeder 16. Non-colored virgin polyethylene thermoplastic polymer pellets are loaded into the hopper 26 of the second gravimetric feeder 18. A first single pigment dispersion in polyethylene thermoplastic polymer pellets containing a red pigment dispersed therein PR-101 red iron oxide is loaded into the hopper 28 of the third gravimetric feeder 20. A second single pigment dispersion in polyethylene thermoplastic polymer pellets a nickel azo yellow (PY 150) pigment dispersed therein is loaded into the hopper 30 of the third gravimetric feeder 22. The computing device 52 is provided with input of an identification number or SKU number corresponding to a desired heathered look color from an input device (not shown), such as a bar code reader or a keyboard. The computing device 52 includes a database of feed rates of color masterbatch pellets and non-colored polymer pellets in order to produce desired heathered look colors. Thus, when the SKU number is entered into the computing device 52 program instructions contained in the computing device search the database to find the feed rates of the color masterbatch pellets and non-colored polymer pellets that correspond to the SKU number. The computing device 52 then uses those feed rates to send signals to the controller 56 to set the individual feed rates for each of the first and second gravimetric feeders 16-18. For example, the vibrator (not shown) associated with the first gravimetric feeder 16 is sent signals to deliver the grass green color masterbatch thermoplastic polymer pellets preferably at a first rate. The vibrator (not shown) associated with the second gravimetric feeder 18 is sent signals to deliver the non-colored thermoplastic polymer pellets preferably at a second rate. The database also has feeding rates for the red first single pigment dispersion and for the yellow second single pigment dispersion. The computing device 52 then uses those feed rates to send signals to the controller 56 to set the individual feed rates for each of the third and fourth gravimetric feeders 20-22. For example, the vibrator (not shown) associated with the third gravimetric feeder 20 is sent signals to deliver the red first single pigment dispersion thermoplastic polymer pellets preferably at a fourth rate. The vibrator (not shown) associated with the fourth gravimetric feeder 22 is sent signals to deliver the yellow second single pigment dispersion thermoplastic polymer pellets preferably at a fourth rate. However, the third and fourth gravimetric feeders 20-22 do not deliver the thermoplastic polymer pellets continuously. The computing device 52 includes program instructions to randomly or intermittently send signals to the third gravimetric feeder 20 to feed the red first single pigment dispersion thermoplastic polymer pellets and to send signals to the fourth gravimetric feeder 22 to not feed the yellow second single pigment dispersion thermoplastic polymer pellets. Also, the computing device 52 includes program instructions to randomly or intermittently send signals to the fourth gravimetric feeder 22 feed the yellow second single pigment dispersion thermoplastic polymer pellets and to send signals to the third gravimetric feeder 20 to not feed the yellow second single pigment dispersion thermoplastic polymer pellets. Additionally, the computing device 52 includes program instructions to randomly and intermittently send signals to the both the third and fourth gravimetric feeders 20-22 to not feed either the red first single pigment dispersion thermoplastic polymer pellets or the yellow second single pigment dispersion thermoplastic polymer pellets. The result of the foregoing is that the grass green color masterbatch and the non-colored thermoplastic polymer pellets are fed to the extruder continuously. But, randomly and intermittently the red single pigment dispersion thermoplastic polymer pellets are fed to the extruder 14 when the yellow second single pigment dispersion thermoplastic polymer pellets are not fed to the extruder; randomly and intermittently the yellow second single pigment dispersion thermoplastic polymer pellets are fed to the extruder when the red first single pigment dispersion thermoplastic polymer pellets are not fed to the extruder and randomly and intermittently neither the red first single pigment dispersion thermoplastic polymer pellets nor the yellow second single pigment dispersion thermoplastic polymer pellets are fed to the extruder. This produces random variations in the color of the extruded fiber 72. Therefore, when the extruded fiber 72 is used to produce, for example, a woven fabric or a tufted carpet, the finished product will have an appealing heathered look.

A third mode of operation of the custom color extrusion system 10 produces a custom color extrusion having a heathered look with the use of a single color masterbatch. For example, a color masterbatch in polyethylene thermoplastic polymer pellets preferably containing approximately 10% to approximately 80% by weight of a custom color pigment blend, such as grass green, is loaded into the hopper 24 of the first gravimetric feeder 16. Non-colored virgin thermoplastic polymer pellets are loaded into the hopper 26 of the second gravimetric feeder 18. The computing device 52 is provided with input of an identification number or SKU number corresponding to a desired heathered look color from an input device (not shown), such as a bar code reader or a keyboard. The computing device 52 includes a database of feed rates of color masterbatch thermoplastic polymer pellets and non-colored thermoplastic polymer pellets in order to produce the desired heathered look colors. Thus, when the SKU number is entered into the computing device 52 program instructions contained in the computing device search the database to find the feed rates of the color masterbatch pellets and the non-colored polymer pellets that correspond to the SKU number. The computing device 52 then uses those feed rates to send signals to the controller 56 to set the individual feed rates for each of the first and second gravimetric feeders 16-18. For example, the vibrator (not shown) associated with the first gravimetric feeder 16 is sent signals to deliver the grass green color masterbatch thermoplastic polymer pellets at a first rate. The vibrator (not shown) associated with the second gravimetric feeder 18 is sent signals to deliver the non-colored thermoplastic polymer pellets at a second rate. The computing device 52 also includes program instructions to randomly and intermittently increase or decrease the rate of feeding the grass green color masterbatch thermoplastic polymer pellets to the extruder relative to the rate of feeding the non-colored thermoplastic polymer pellets to the extruder. This results in a random increase or decrease of the relative proportion of the grass green color masterbatch thermoplastic polymer pellets relative to the non-colored thermoplastic polymer pellets. The increased proportion of the grass green color masterbatch thermoplastic polymer pellets produces a more intense or deeper color in the extruded fiber 72. Similarly, the decreased proportion of the grass green color masterbatch thermoplastic polymer pellets produces a less intense or lighter color in the extruded fiber 72. This produces random variation in the color of the extruded fiber 72. Therefore, when the extruded fiber 72 is used to produce, for example, a woven fabric or a tufted carpet, the finished product will have an appealing heathered look to it.

A fourth mode of operation of the custom color extrusion system 10 produces a custom color extrusion having a variegated or camouflage look with the use of a single color masterbatch. For example, a color masterbatch in thermoplastic polymer pellets preferably containing approximately 10% to approximately 80% by weight of a custom color pigment blend, such as grass green, is loaded into the hopper 24 of the first gravimetric feeder 16. Non-colored virgin thermoplastic polymer pellets are loaded into the hopper 26 of the second gravimetric feeder 18. The computing device 52 is provided with input of an identification number or SKU number corresponding to a desired variegated look color from an input device (not shown), such as a bar code reader or a keyboard. The computing device 52 includes a database of feed rates of color masterbatch pellets and non-colored polymer pellets in order to produce desired variegated look colors. Thus, when the SKU number is entered into the computing device 52 program instructions contained in the computing device search the database to find the feed rates of the color masterbatch pellets and non-colored polymer pellets that correspond to the SKU number. The computing device 52 then uses those feed rates to send signals to the controller 56 to set the individual feed rates for each of the first and second gravimetric feeders 16-18. For example, the vibrator (not shown) associated with the first gravimetric feeder 16 is sent signals to deliver the grass green color masterbatch thermoplastic polymer pellets at a first rate. The vibrator (not shown) associated with the second gravimetric feeder 18 is sent signals to deliver the non-colored thermoplastic polymer pellets at a second rate. The computing device 52 also includes program instructions to randomly and intermittently pause feeding the grass green color masterbatch thermoplastic polymer pellets to the extruder while the rate of feeding the non-colored thermoplastic polymer pellets to the extruder is maintained (or slightly increased by an amount equal to the rate that the color masterbatch thermoplastic polymer pellets were being fed before they were paused). The computing device 52 also includes program instructions to randomly determine the duration of the pause, with a maximum pause rate being specified in the data in the database corresponding to the SKU number. This information is used to control when and how long grass green thermoplastic polymer pellets are dispensed from the first gravimetric feeder 16. This produces a variegated look to the extruded fiber 72, with alternating green and colorless portions randomly dispersed along the length of the extruded fiber.

A variation of the fourth mode of operation of the custom color extrusion system 10 produces a custom color extrusion having a variegated look with the use of two or more different color masterbatch polymer pellets. For example, a first color masterbatch in polyethylene thermoplastic polymer pellets preferably containing approximately 10% to approximately 80% by weight of a custom color pigment blend, such as grass green, is loaded into the hopper 24 of the first gravimetric feeder 16. Non-colored virgin polyethylene thermoplastic polymer pellets are loaded into the hopper 26 of the second gravimetric feeder 18. A second color masterbatch in polyethylene thermoplastic polymer pellets preferably containing approximately 10% to approximately 80% by weight of a custom color pigment blend, such as brown, is loaded into the hopper 28 of the third gravimetric feeder 20. The computing device 52 is provided with input of an identification number or SKU number corresponding to a desired variegated look color from an input device (not shown), such as a bar code scanner or a keyboard. The computing device 52 includes a database of feed rates of the first and second color masterbatch pellets and the non-colored polymer pellets in order to produce the desired variegated look colors. Thus, when the SKU number is entered into the computing device 52 program instructions contained in the computing device search the database to find the feed rates of the first and second color masterbatch thermoplastic polymer pellets and the non-colored thermoplastic polymer pellets that correspond to the SKU number. The computing device 52 then uses those feed rates to send signals to the controller 56 to set the individual feed rates for each of the first, second and third gravimetric feeders 16-20. For example, the vibrator (not shown) associated with the first gravimetric feeder 16 is sent signals to deliver the grass green color masterbatch thermoplastic polymer pellets at a first rate. The vibrator (not shown) associated with the second gravimetric feeder 18 is sent signals to deliver the non-colored thermoplastic polymer pellets at a second rate. The vibrator (not shown) associated with the third gravimetric feeder 16 is sent signals to deliver the brown color masterbatch thermoplastic polymer pellets at a third rate. The computing device 52 also includes program instructions to deliver the non-colored thermoplastic polymer pellets to the extruder 14 at a constant rate. The computing device 52 further includes program instructions to randomly alternate the feeding of the grass green color masterbatch thermoplastic polymer pellets to the extruder 14 and the brown color masterbatch thermoplastic polymer pellets to the extruder. That it, when the grass green color masterbatch thermoplastic polymer pellets are fed to the extruder 14, the brown color masterbatch thermoplastic polymer pellets are not fed to the extruder. Conversely, when the brown color masterbatch thermoplastic polymer pellets are fed to the extruder 14, the grass green color masterbatch thermoplastic polymer pellets are not fed to the extruder. The computing device 52 also includes program instructions to randomly determine the duration of the pause of the feeding of the green color masterbatch and the brown color masterbatch, with a maximum pause rate being specified in the data in the database corresponding to the SKU number. This information is used to control when and how long grass green thermoplastic polymer pellets are dispensed from the first gravimetric feeder 16 and when and how long brown thermoplastic polymer pellets are dispensed from the third gravimetric feeder 20. This produces a variegated or camouflage look to the extruded fiber 72, with alternating green and brown portions randomly dispersed along the length of the extruded fiber.

A fifth mode of operation of the custom color extrusion system 10 produces a delustered custom color extrusion. Delustering is a process by which the luster or sheen of a textile, yarn or fabric is reduced. The fifth mode of operation can be used with any of the modes of operation described above. The fifth mode of operation comprises feeding to the extruder 14 a pellet or granule of a thermoplastic polymer containing titanium dioxide (TiO₂) in combination with either the color master batch thermoplastic polymer pellets or the single pigment dispersion thermoplastic polymer pellets and non-colored thermoplastic polymer pellets, as described above. For example, in the first mode the first single pigment dispersion thermoplastic polymer pellets, the second single pigment dispersion thermoplastic polymer pellets, the third single pigment dispersion thermoplastic polymer pellets and the non-colored thermoplastic polymer pellets are fed to the extruder 14 in the same manner as described above. In the fifth mode of operation, thermoplastic polymer pellets containing titanium dioxide dispersed therein are also feed to the extruder 14 using a fifth gravimetric feeder (not shown) which operates in the same manner as the gravimetric feeders 16-22. The thermoplastic polymer pellets containing titanium dioxide are fed to the extruder 14 at a rate and the titanium dioxide in the thermoplastic polymer pellets is at a concentration such that the extruded fiber 72 is delustered. Preferably the extruded fiber 72 contains approximately 0.05% to approximately 0.8% by weight titanium dioxide, more preferably approximately 0.07% to approximately 0.5% by weight titanium dioxide, especially approximately 0.3% by weight titanium dioxide. For example, thermoplastic polymer pellets containing titanium dioxide dispersed therein can be prepared by combining titanium dioxide in powder form and a thermoplastic polymer in powder form, such as polyethylene powder. These two powders are blended together at a concentration of 50% by weight titanium dioxide. The blend is then fed to an extruder, which extrudes the blend into a strand that is then pelletized. Those pellets can be used in the present invention as described above. For example, the thermoplastic polymer pellets containing 50% by weight titanium dioxide dispersed therein can be fed to the extruder 14 at a let down rate of 0.6% by weight which produces a final concentration of 0.3% by weight in the extruded fiber 72 produced in the first mode of operation, as described above.

In another disclosed embodiment of the fifth mode of operation, first single pigment dispersion in thermoplastic polymer pellets are loaded into the hopper 24 of the first gravimetric feeder 16, second single pigment dispersion in thermoplastic polymer pellets are loaded into the hopper 26 of the second gravimetric feeder 18, non-colored thermoplastic polymer pellets are loaded into the hopper 28 of the third gravimetric feeder 20, and thermoplastic polymer pellets having titanium dioxide dispersed therein are loaded into the hopper 30 of the fourth gravimetric feeder 22. The computing device 52 is provided with input of an identification number or SKU number corresponding to a desired color from an input device (not shown), such as a bar code reader or a keyboard. The computing device 52 includes a database of feed rates of single pigment dispersion thermoplastic polymer pellets and non-colored thermoplastic polymer pellets in order to produce desired colors. Thus, when the SKU number is entered into the computing device 52 program instructions contained in the computing device search the database to find the feed rates of single pigment dispersion thermoplastic polymer pellets and non-colored thermoplastic polymer pellets that correspond to the SKU number. The database also includes a feed rate for the titanium dioxide dispersion thermoplastic polymer pellets. The computing device 52 then uses those feed rates to send signals to the controller 56 to set the individual feed rates for each of the gravimetric feeders 16-22. The thermoplastic polymer pellets from the gravimetric feeders 16-22 are fed to the extruder 14 that extrudes the thermoplastic polymer pellets into a desired shape, such as the extruded fiber 72. The color photometer 76 provides feedback, as described above, to adjust the feed rates of the gravimetric feeders 16-22 in order to achieve the desired color. The result of this process is an extruded fiber 72 of a desired color that is delustered.

In another disclosed embodiment of the fifth mode of operation, color masterbatch thermoplastic polymer pellets are loaded into the hopper 24 of the first gravimetric feeder 16, non-colored thermoplastic polymer pellets are loaded into the hopper 26 of the second gravimetric feeder 18, and thermoplastic polymer pellets having titanium dioxide dispersed therein are loaded into the hopper 28 of the third gravimetric feeder 20. The computing device 52 is provided with input of an identification number or SKU number corresponding to a desired color from an input device (not shown), such as a bar code reader or a keyboard. The computing device 52 includes a database of feed rates of color masterbatch thermoplastic polymer pellets and non-colored thermoplastic polymer pellets in order to produce desired colors. Thus, when the SKU number is entered into the computing device 52 program instructions contained in the computing device search the database to find the feed rates of color masterbatch thermoplastic polymer pellets and non-colored thermoplastic polymer pellets that correspond to the SKU number. The database also includes a feed rate for the titanium dioxide dispersion thermoplastic polymer pellets. The computing device 52 then uses those feed rates to send signals to the controller 56 to set the individual feed rates for each of the gravimetric feeders 16-20. The thermoplastic polymer pellets from the gravimetric feeders 16-20 are fed to the extruder 14 that extrudes the thermoplastic polymer pellets into a desired shape, such as the extruded fiber 72. The color photometer 76 provides feedback, as described above, to adjust the feed rates of the gravimetric feeders 16-18 in order to achieve the desired color. The result of this process is an extruded fiber 72 of a desired color that is delustered.

A sixth mode of operation of the custom color extrusion system 10 produces a fire resistant polymer extrusion of a desired color. The sixth mode of operation can be used with any of the modes of operation described above. The sixth mode of operation comprises feeding to the extruder 14 a pellet or granule of a thermoplastic polymer containing a fire retardant dispersed therein in combination with either the color master batch thermoplastic polymer pellets or the single pigment dispersion thermoplastic polymer pellets, as described above. A novel aspect of the sixth mode of operation is that the thermoplastic polymer pellets or granules containing a fire retardant dispersed therein is intermittently fed to the extruder while the color master batch thermoplastic polymer pellets or the single pigment dispersion thermoplastic polymer pellets and non-colored thermoplastic polymer pellets are fed continuously or at varying rates as specified above. This produces a continuous extrudate that comprises portions that have the fire retardant incorporated therein and portions that do not have fire retardant incorporated therein. The thermoplastic polymer pellets containing the fire retardant are fed to the extruder 14 at a rate and the fire retardant in the thermoplastic polymer pellets is at a concentration such that the extruded fiber 72 portions containing fire retardant preferably contains approximately 0.05% to approximately 25% by weight fire retardant, more preferably approximately 0.1% to approximately 5% by weight fire retardant, especially approximately 3% by weight fire retardant. For example, thermoplastic polymer pellets containing fire retardant dispersed therein can be prepared by combining fire retardant in powder form and a thermoplastic polymer in powder form, such as polypropylene powder. These two powders are blended together at a concentration of approximately 10% to approximately 50% by weight fire retardant, especially approximately 3% by weight fire retardant. The blend is then fed to an extruder, which extrudes the blend into a strand that is then pelletized. Those pellets can be used in the present invention as described above. Many fire retardants for thermoplastic polymers are known in the art. Those fire retardants that can be compounded into a thermoplastic polymer pellet or granule can be used in the present invention. Fire retardants that can be used in the present invention include, but are not limited to phosphorous based, nitrogen based, hydrated metals, antimony trioxide, and halogenated based components, non-halogenated based components.

In one disclosed embodiment of the sixth mode of operation, first single pigment dispersion in thermoplastic polymer pellets are loaded into the hopper 24 of the first gravimetric feeder 16, second single pigment dispersion in thermoplastic polymer pellets are loaded into the hopper 26 of the second gravimetric feeder 18, non-colored thermoplastic polymer pellets are loaded into the hopper 28 of the third gravimetric feeder 20, and thermoplastic polymer pellets having fire retardant dispersed therein are loaded into the hopper 30 of the fourth gravimetric feeder 22. The computing device 52 is provided with input of an identification number or SKU number corresponding to a desired color from an input device (not shown), such as a bar code reader or a keyboard. The computing device 52 includes a database of feed rates of single pigment dispersion thermoplastic polymer pellets and non-colored thermoplastic polymer pellets in order to produce desired colors. Thus, when the SKU number is entered into the computing device 52 program instructions contained in the computing device search the database to find the feed rates of single pigment dispersion thermoplastic polymer pellets and non-colored thermoplastic polymer pellets that correspond to the SKU number. The database also includes a feed rate for the fire retardant dispersion thermoplastic polymer pellets. The computing device 52 then uses those feed rates to send signals to the controller 56 to set the individual feed rates for each of the gravimetric feeders 16-22. The database also include information regarding the frequency of pausing the feeding of the fire retardant dispersion thermoplastic polymer pellets and the duration of each pause. The computing device 52 includes program instructions that intermittently turn the fourth gravimetric feeder 22 on and off thereby pausing the feeding of the fire retardant dispersion thermoplastic polymer pellets to the extruder 14 at a desired frequency and a desired duration. Preferably, the feeding of the fire retardant dispersion thermoplastic polymer pellets is paused for a duration such that approximately 0.1% to approximately 50% by volume of the extruded fiber 72 includes fire retardant and approximately 0.2% to approximately 10% by volume of the extruded fiber does not include fire retardant, more preferably approximately 5% to approximately 7% by volume of the extruded fiber includes fire retardant and approximately 0.5% to approximately 3% by volume of the extruded fiber does not include fire retardant, especially approximately 50% by volume of the extruded fiber includes fire retardant and approximately 50% by volume of the extruded fiber does not include fire retardant. The thermoplastic polymer pellets from the gravimetric feeders 16-22 are fed to the extruder 14. However, the fire retardant dispersion thermoplastic polymer pellets are intermittently fed to the extruder 14. The extruder 14 extrudes the thermoplastic polymer pellets into a desired shape, such as the extruded fiber 72. The color photometer 76 provides feedback, as described above, to adjust the feed rates of the gravimetric feeders 16-20 in order to achieve the desired color. The result of this process is a continuously produced extruded fiber 72 of a desired color that includes portions that include fire retardant and portions that do not include fire retardant along the length of the extruded fiber.

Thermoplastic polymers that are useful for the thermoplastic polymer pellets or granules include, but are not limited to, thermoplastic polymers for artificial turf, compounding thermoplastics, engineering thermoplastics, high temperature thermoplastics and thermoplastic elastomers. Thermoplastic polymers for artificial turf include, but are not limited to, polyethylene (PE), low density polyethylene (LDPE), linear low density polyethylene (LLDPE), polypropylene (PP) or polyamide (PA). Polyethylene has the formula (C₂H₄)ₙ. Low density polyethylene has a density range of approximately 0.91 to 0.94 g/cm³. Linear low density polyethylene is a substantially linear polymer (polyethylene), with significant numbers of short branches, commonly made by copolymerization of ethylene with longer-chain olefins. Linear low-density polyethylene differs structurally from conventional low-density polyethylene (LDPE) because of the absence of long chain branching. Polypropylene has the formula (C₃H₆)ₙ. Polyamide includes, but is not limited to, Nylon and Nylon 6, which is also known as polycaprolactam.

Compounding thermoplastics include, but are not limited to, acrylonitrile butadiene styrene copolymer (ABS), styrene acrylonitrile copolymer (SAN), polystyrene (PS), high density polyethylene (PE HD), ethylene-vinyl acetate (EVA), polylactic acid (PLA), polybutylene terephthalate (PBT), polyethylene terephthalate (PET). Acrylonitrile butadiene styrene copolymer has the formula (C₈H₈)ₓ.(C₄H₆)_{y}.(C₃H₃N)_{z}. Styrene acrylonitrile copolymer has the formula (C₈H₈)ₙ—(C₃H₃N)ₘ. Polystyrene has the formula (C₈H₈)ₙ. Ethylene-vinyl acetate has the formula (C₂H₄)ₙ(C₄H₆O₂)ₙ. Polylactic acid has the formula (C₃H₄O₂)ₙ. Polybutylene terephthalate has the formula (C₁₂H₁₂O₄)ₙ. Polyethylene terephthalate has the formula (C₁₀H₈O₄)ₙ.

Engineering thermoplastics include, but are not limited to, polyamide 11 (PA 11), polyamide 12 (PA 12), polyamide 66 (PA 66), polycarbonate (PC), polymethyl methacrylate (PMMA) or polyoxymethylene (POM). High temperature thermoplastics include, but are not limited to, polyphenylene sulfide (PPS), polysulfone (PSU), polyether ether ketone (PEEK). Thermoplastic elastomers include, but are not limited to, thermoplastic olefin (TPE-O), thermoplastic polyurethane (TPE-U), thermoplastic copolyester elastomer (TPE-C), thermoplastic polyamides (TPE-A) and styrenic block copolymers (TPE-S).

The color masterbatch preferably includes one or more pigments and optional additives dispersed in a thermoplastic carrier polymer to provide the desired color or shade to the first thermoplastic polymer when the first thermoplastic polymers and the thermoplastic polymer color masterbatch are melted and blended together, such as during extrusion. The preparation of a thermoplastic polymer color masterbatch is a process that is well known in the art. The pigments that can be used in the present invention for the thermoplastic polymer color masterbatch are those that are well known in the art for coloring thermoplastic polymers. The pigments can be organic or inorganic. Some typical pigments used to color thermoplastic polymers include, but are not limited to, phthalocyanine blues and greens, titanium dioxide, zinc oxide, antimony trioxide, iron yellow oxide, red iron oxide, ferric ammonium ferrocyanide, iron blue, chrome yellow, carbon black, aluminum flakes, chromium titanate, bismuth vanadate yellow, zinc ferrite, mixtures thereof and the like. The amount of pigment used in the color masterbatch is that amount that is effective to provide the desired color or shade to the extruded polymer. The pigments preferably comprise approximately 5% to approximately 80% by weight of the thermoplastic carrier polymer of the color masterbatch; more preferably approximately 20% to approximately 80% by weight; most preferably approximately 20% to approximately 50% by weight. The foregoing ranges of concentrations of components include all of the intermediate values.

The color masterbatch thermoplastic polymer pellets can also include additives that are optionally added to thermoplastic polymers. For example, the color masterbatch thermoplastic polymer pellets can optionally include ultraviolet light absorber compounds (UVA), antioxidants (AO), hindered amine light stabilizers (HALS), fillers, antistatic compounds, lubricants, fire retardants, mold release agents, blowing agents, antimicrobials and the like. The amounts of these materials that are added to the extrudable mixture are those amounts that are typically used in the art. Calcium carbonate is a typical material used as an inert filler for thermoplastics. Clays, such as kaolin, quartz and silica flours can also be used as fillers for thermoplastics. Fillers can also be used to change the mechanical properties of the thermoplastic, such as surface finish, water absorption and chemical and weathering resistance. Most thermoplastic polymers react with oxygen, which causes the polymer to lose physical and mechanical properties. Therefore, it is common to add antioxidants to thermoplastics. Antioxidants inhibit the oxidation reaction by combining with free radicals or by reacting with hydroperoxides. Antioxidants suitable for use in the present invention are commercially available and include, but are not limited to, Irgafos 168, Irganox 1098, Irganox 1076, Irganox 1010 available from BASF Corporation, Florham Park, N.J. Primary antioxidants, such as hindered phenolics and secondary amines, are radical scavengers. Hindered phenolic antioxidants include, but are not limited to, butylated hydroxytoluene and 2,6-di-t-butyl-4-methylphenol. Secondary amine antioxidants include, but are not limited to, phosphites and thioesters. The additives are added to the thermoplastic polymer color masterbatch in the same manner as the pigments and in amounts typically used in the art. Ultraviolet light absorber compounds are commercially available and include, but are not limited to, Tinuvin 234, Tinuvin 360, Tinuvin 1577 available from BASF Corporation, Horham Park, N.J. Hindered amine light stabilizers are commercially available and include, but are not limited to, Tinuvin 944, Tinuvin 119, Tinuvin NOR 116 available from BASF Corporation, Horham Park, N.J.

The color masterbatch thermoplastic polymer pellets and the non-colored thermoplastic polymer pellets preferably are made from compatible polymer. Similarly, the single pigment dispersion thermoplastic polymer pellets and the non-colored thermoplastic polymer pellets preferably are made from compatible polymer. As used herein, the term “compatible” means that the non-colored thermoplastic polymer and the thermoplastic carrier polymer used for the color masterbatch when melted and mixed together cause the pigments in color masterbatch to uniformly disperse in the non-colored thermoplastic polymer thereby providing a uniform color or shade to the extruded thermoplastic polymer. For example, ethylene-vinyl acetate (EVA) and low density polyethylene (LDPE) can be used as the masterbatch carriers polymer for polyolefin host polymers and nylon and polystyrene can be used as the masterbatch carrier polymer for butadiene styrene copolymer (ABS) and styrene acrylonitrile copolymer (SAN). Preferably, when melted the thermoplastic polymer of the color masterbatch or single pigment dispersion is miscible with the non-colored thermoplastic polymer.

The present invention has been describes as being practiced with thermoplastic polymer pellets. However, it is specifically contemplated that the present invention can also be practiced with thermoplastic polymer granules. The non-colored thermoplastic polymer, the color masterbatch thermoplastic polymer and the single pigment dispersion thermoplastic polymer are all preferably in the form of extruded pellets or granules. Each of the pellets or granules of the non-colored thermoplastic polymer and the color masterbatch thermoplastic polymer preferably has a size greater than or equal to approximately 60 pellets or granules per gram; more preferably approximately 30 to approximately 60 pellets or granules per gram. Each of the pellets or granules of the single pigment dispersion thermoplastic polymer preferably has a size greater than or equal to approximately 400 pellets or granules per gram; more preferably approximately 30 to approximately 400 pellets per gram; most preferably approximately 150 to approximately 400 pellets or granules per gram.

The following examples are illustrative of selected embodiments of the present invention and are not intended to limit the scope of the invention. All percentages are by weight unless otherwise noted.

### Example 1

This is an embodiment of the first mode of operation of the custom color extrusion system 10 described above. In this example, five precision gravimetric feeders are employed instead of the four described above. Single pigment dispersions in polyethylene terephthalate (PET) are used. The single pigment dispersions are in pellet form having a size of approximately 60 pellets per gram.

A first gravimetric feeder is provided with a single pigment dispersion of 50% by weight Chrome Titanate (PBr24). The first gravimetric feeder is controlled by the computing device to provide a letdown rate of 0.5616% by weight. A second gravimetric feeder is provided with a single pigment dispersion of 50% by weight red iron oxide (PR-101). The second gravimetric feeder is controlled by the computer to provide a letdown rate of 0.076% by weight. A third gravimetric feeder is provided with a single pigment dispersion of 50% by white titanium dioxide (PW6). The third gravimetric feeder is controlled by the computer to provide a letdown rate of 0.0400% by weight. A fourth gravimetric feeder is provided with a single pigment dispersion of 5% by weight carbon black (PBK 7). The fourth gravimetric feeder is controlled by the computer to provide a letdown rate of 0.2160% by weight. A fifth gravimetric feeder is provided with 100% by weight non-colored polyethylene terephthalate polymer pellets of a size of approximately 60 pellets per gram. The fifth gravimetric feeder is controlled by the computer to provide a letdown rate of 99.1064% by weight.

The five gravimetric feeders feed their respective components at the foregoing letdown rates into the funnel 40. The polymer pellets fall into the funnel 40 from the five gravimetric feeders and then into the tube 70 and from the tube into the throat of the extruder 14. The four different colored single pigment dispersion thermoplastic polymer pellets and the non-colored thermoplastic polymer pellets are melted, mixed and extruded by the extruder 14 into the fiber 72.

### Example 2

This example is the same as Example 1, except that the color of the extruded fiber 72 is determined to be out of specification; i.e., the color of the fiber is too red by 1.0 unit (da*). In the prior art, only the ratio of the custom color concentrate could be adjusted making a color shift impossible.

In the present invention, the letdown rates of the five gravimetric feeders can be adjusted individually as needed to thereby provide a desired color shift. In the present example, the color photometer 76 measures the actual color of the extruded fiber 72. In the present case, the measured color of the extruded fiber is determined to be too red by 1.0 unit (da*). The color photometer 76 sends this measured color information to the computing device 52, which then send signals to the five gravimetric feeders to reduce the feed rate of the second gravimetric feeder to 0.0700% by weight and to increase the feed rate of the fifth gravimetric feeder to 99.1124% by weight. This change in the feed rates of the second and fifth gravimetric feeders brings the color of the extruded fiber 72 back into specification.

### Example 3

This example discloses an embodiment of the introduction of random color variation or “color noise” into an extruded fiber 72. Such an effect was not possible in the prior art.

This example is identical to Example 1, except for the random adjustment of the feed rates of one or more of the five gravimetric feeders. The first gravimetric feeder that contains the 50% by weight Chrome Titanate (PBr24) randomly changes it's letdown feed rate from 0.5335% to 0.5897% by weight (this is an adjustment of +/−5% by weight of the targeted value). The computing device 52 is programmed to randomly make this feed rate adjustment to the first gravimetric feeder. The duration of the feed rate to the first gravimetric feeder is also randomly adjusted. Thus, the feed rate of 0.5335% can be for a duration of two minutes followed by a duration of the feed rate of 0.5897% for a duration of one minute followed by a feed rate of 0.5335% for a duration of three minutes, etc. This creates a random “noise” in the coloration of the extruded fiber 72. This effect reduces the probability of streaks in a carpet tufted using the extruded fiber 72. This method moves the color in one axis (db*) due to the change in the yellow component. Alternatively or additionally, the red component can be randomly adjusted to move the color of the extruded fiber 72 in a second axis (da*). Additionally, the black and white component can be randomly adjusted to move the color in a third axis (dl*).

### Example 4

This example discloses an embodiment for creating a camouflage effect in the extruded fiber 72. This example is identical to Example 1, except one or more of the gravimetric feeders is turned on and off periodically. The first gravimetric feeder that contains the 50% by weight Chrome Titanate (PBr24) periodically changes its letdown feed rate from 0.5616% to 0% by weight, which correspond to the term turning the feeder on and off. Thus, the first gravimetric feeder is turned on for 10 minutes and then turned off for ten minutes. The on/off process is then repeated. This results in a portion of the extruded fiber 72 including the four colors; i.e., yellow Chrome Titanate, red iron oxide, white titanium dioxide and black and another adjacent portion of the same extruded fiber including three colors; i.e., red iron oxide, white titanium dioxide and black. This same process can be practiced by turning one or more of the gravimetric feeders on and off; such as turning the first and second gravimetric feeders on and off. Alternatively, a combination of different gravimetric feeders can be turned on and off. For example, the first gravimetric feeder can be turned off for a period of time. Then, when the first gravimetric feeder is turned back on the second gravimetric feeder is turned off for a period of time. Then, when the second gravimetric feeder is turned back on, the fourth gravimetric feeder is turned off for a period of time. The length of time that the gravimetric feeder or feeders are turned off and on can also be adjusted to any desired interval or the on/off interval can be a random period of time. Furthermore, when one or more of the gravimetric feeders is turned off, the feed rate of the fifth gravimetric feeder containing the non-colored 100% by weigh PET is increased by an amount equal to the feed rate of the feeder or feeders that were turned off. Additionally, although it is preferred that one or more of the feeders be turned off and on in this embodiment, a similar effect can be produced by reducing the feed rate of one or more of the gravimetric feeders containing the single pigment dispersions, such as cutting the feed rate by 50% to 95% of its original rate.

### Example 5

This example discloses an embodiment for producing a fire retardant extruded fiber using the extrusion system 10 described above. In this example, six precision gravimetric feeders are employed instead of the four described above. Single pigment dispersions in polyethylene terephthalate (PET) are used. The single pigment dispersions are in pellet form having a size of approximately 60 pellets per gram.

A first gravimetric feeder is provided with a single pigment dispersion of 50% by weight Chrome Titanate (PBr24). The first gravimetric feeder is controlled by the computing device to provide a letdown rate of 0.5616% by weight. A second gravimetric feeder is provided with a single pigment dispersion of 50% by weight red iron oxide (PR-101). The second gravimetric feeder is controlled by the computing device to provide a letdown rate of 0.0760% by weight. A third gravimetric feeder is provided with a single pigment dispersion of 50% by white titanium dioxide (PW6). The third gravimetric feeder is controlled by the computing device to provide a letdown rate of 0.0400% by weight. A fourth gravimetric feeder is provided with a single pigment dispersion of 5% by weight black (PB 7). The fourth gravimetric feeder is controlled by the computing device to provide a letdown rate of 0.2160% by weight. A fifth gravimetric feeder is provided with 5% by weight fire retardant dispersion in 95% by weight polyethylene terephthalate pellets having a size of 60 pellets per gram. The fifth gravimetric feeder is controlled by the computing device to provide a letdown rate of 5% by weight. A sixth gravimetric feeder is provided with 100% by weight non-colored polyethylene terephthalate polymer pellets of a size of approximately 60 pellets per gram. The fifth gravimetric feeder is controlled by the computing device to provide a letdown rate of 94.1064% by weight.

The fifth gravimetric feeder that contains the fire retardant pellets periodically changes its letdown feed rate from 5% to 0% by weight. Thus, the fifth gravimetric feeder is turned on for 10 minutes and then turned off for ten minutes. The on/off process is then repeated. This results in a portion of the extruded fiber 72 including the four colors; i.e., yellow Chrome Titanate, red iron oxide, white titanium dioxide and black plus 2.5% by weight fire retardant and another adjacent portion of the same extruded fiber including the same four colors but no fire retardant. The length of time that the fifth gravimetric feeder containing the fire retardant is turned off and on can also be adjusted to any desired interval or the on/off interval can be a random period of time. Furthermore, when the fifth gravimetric feeder is turned off, the feed rate of the sixth gravimetric feeder is increased by 5% by weight. Additionally, although it is preferred that the fifth gravimetric feeder containing the fire retardant be turned off and on in this embodiment, a similar effect can be produced by reducing the feed rate of the gravimetric feeder containing the fire retardant, such as cutting the feed rate by 50% to 90% of its original rate. By adding fire retardant to only a portion of the extruded fiber, the same fire retardant effect in a finished product, such as a tufted carpet, can be produced with a reduced amount of fire retardant material thereby making this process much more inexpensive that current fire retardant techniques.

### Example 6

This example discloses an embodiment for delustering an extruded fiber. In this example, only two gravimetric feeders are needed. A first gravimetric feeder is provided with a single pigment dispersion of 50% by weight titanium dioxide (PW 6). The first gravimetric feeder is controlled by the computing device to provide a letdown rate of 0.6% by weight. A second gravimetric feeder is provided with 100% by weight non-colored polyethylene terephthalate polymer pellets of a size of approximately 60 pellets per gram. The second gravimetric feeder is controlled by the computer to provide a letdown rate of 99.4% by weight. The resulting extruded fiber contains 0.3% by weight titanium dioxide (TiO₂), which delusters the extruded fiber.

It should be understood, of course, that the foregoing relates only to certain disclosed embodiments of the present invention and that numerous modifications or alterations may be made therein without departing from the spirit and scope of the invention as set forth in the appended claims.

What is claimed is:

1. A method comprising:
feeding first single pigment dispersion thermoplastic polymer pellets or granules to an extruder from a first gravimetric feeder operatively connected to a computing device and adapted to receive signals from the computing device to control the amount of the first single pigment dispersion thermoplastic polymer pellets or granules dispensed therefrom;
feeding second single pigment dispersion thermoplastic polymer pellets or granules to the extruder from a second gravimetric feeder operatively connected to the computing device and adapted to receive signals from the computing device to control the amount of the second single pigment dispersion thermoplastic polymer pellets or granules dispensed therefrom;
feeding a non-colored thermoplastic polymer pellets or granules to the extruder from a third gravimetric feeder operatively connected to the computing device and adapted to receive signals from the computing device to control the amount of non-colored thermoplastic polymer pellets or granules dispensed therefrom;
measuring the color of the extruded polymer using a photo colorimeter operatively connected to the computing device and adapted to send signals to the computing device corresponding to the color of the extruded polymer;
wherein the computing device is adapted to receive signals from the photo colorimeter corresponding to the color of the extruded polymer and the computing device includes program instructions for comparing the measured color of the extruded polymer to a desired color of the extruded polymer and determine a difference therebetween; and
wherein the computing device is adapted to send signals to the first, second and third gravimetric feeders to separately adjust the rates at which the first, second and third gravimetric feeders each feed the first single pigment dispersion thermoplastic polymer pellets or granules, the second single pigment dispersion thermoplastic polymer pellets or granules and the non-colored thermoplastic polymer pellets or granules to the extruder in response to the difference between the measured color of the extruded polymer and the desired color of the extruded polymer.

2. A method comprising:
feeding color masterbatch thermoplastic polymer pellets or granules to an extruder from a first gravimetric feeder operatively connected to a computing device and adapted to receive signals from the computing device to control the amount of the color masterbatch dispensed therefrom;
selectively feeding first single pigment dispersion thermoplastic polymer pellets or granules to the extruder from a second gravimetric feeder operatively connected to the computing device and adapted to receive signals from the computing device to control the amount of the single pigment dispersion thermoplastic polymer pellets or granules dispensed therefrom;
selectively feeding second single pigment dispersion thermoplastic polymer pellets or granules to the extruder from a third gravimetric feeder operatively connected to the computing device and adapted to receive signals from the computing device to control the amount of the second single pigment dispersion thermoplastic polymer pellets or granules dispensed therefrom;
feeding non-colored thermoplastic polymer pellets to the extruder from a fourth gravimetric feeder operatively connected to the computing device and adapted to receive signals from the computing device to control the amount of non-colored thermoplastic polymer pellets or granules dispensed therefrom;
wherein the computing device is adapted to send signals to the first, second, third and fourth gravimetric feeders to separately adjust the rates at which the first, second, third and fourth gravimetric feeders each feed the color masterbatch thermoplastic polymer pellets or granules, the first single pigment dispersion thermoplastic polymer pellets or granules, the second single pigment dispersion thermoplastic polymer pellets or granules and the non-colored thermoplastic polymer pellets or granules to the extruder;
wherein the first and fourth gravimetric feeders are sent signals to continuously feed the color masterbatch thermoplastic polymer pellets and the non-colored thermoplastic polymer pellets to the extruder;
wherein in second gravimetric feeder is randomly sent signals to feed the first single pigment dispersion thermoplastic polymer pellets or granules to the extruder and the third gravimetric feeder is sent signals to not feed any second single pigment dispersion thermoplastic polymer pellets or granules to the extruder; and
wherein in third gravimetric feeder is randomly sent signals to feed the second single pigment dispersion thermoplastic polymer pellets or granules to the extruder and the first gravimetric feeder is sent signals to not feed any first single pigment dispersion thermoplastic polymer pellets or granules to the extruder.

3. A method comprising:
selectively feeding color masterbatch thermoplastic polymer pellets or granules to an extruder from a first gravimetric feeder operatively connected to a computing device and adapted to receive signals from the computing device to control the amount of the color masterbatch polymer pellets or granules dispensed therefrom;
feeding a non-colored thermoplastic polymer pellets or granules to the extruder from a second gravimetric feeder operatively connected to the computing device and adapted to receive signals from the computing device to control the amount of non-colored thermoplastic polymer pellets or granules dispensed therefrom;
wherein the computing device is adapted to send signals to the first and second gravimetric feeders to separately adjust the rates at which the first and second gravimetric feeders each feed the color masterbatch thermoplastic polymer pellets or granules and the non-colored thermoplastic polymer pellets or granules to the extruder;
wherein the second gravimetric feeder is sent signals to continuously feed the non-colored thermoplastic polymer pellets or granules to the extruder; and
wherein the first gravimetric feeder is randomly sent signals to feed the color masterbatch polymer pellets or granules to the extruder and randomly sent signals to not feed the color masterbatch thermoplastic polymer pellets or granules to the extruder.

4. The method of claim 3, wherein the second gravimetric feeder is sent signals to increase the rate of feeding the non-colored thermoplastic polymer pellets or granules to the extruder when signals are sent to the first gravimetric feeder to not feed the color masterbatch thermoplastic polymer pellets or granules to the extruder.

5. A method comprising:
selectively feeding color masterbatch thermoplastic polymer pellets or granules to an extruder from a first gravimetric feeder operatively connected to a computing device and adapted to receive signals from the computing device to control the amount of the color masterbatch thermoplastic polymer pellets or granules dispensed therefrom;
feeding non-colored thermoplastic polymer pellets or granules to the extruder from a second gravimetric feeder operatively connected to the computing device and adapted to receive signals from the computing device to control the amount of non-colored polymer pellets or granules dispensed therefrom;
wherein the computing device is adapted to send signals to the first and second gravimetric feeders to separately adjust the rates at which the first and second gravimetric feeders each feed the color masterbatch thermoplastic polymer pellets or granules and the non-colored thermoplastic polymer pellets or granules to the extruder;
wherein the second gravimetric feeders is sent signals to continuously feed the non-colored thermoplastic polymer pellets or granules to the extruder at a desired rate; and
wherein the first gravimetric feeder is randomly sent signals to feed the color masterbatch thermoplastic polymer pellets or granules to the extruder at a first rate and randomly sent signals to feed the color masterbatch thermoplastic polymer pellets or granules to the extruder at a second rate that is different from the first rate.

6. The method of claim 5, wherein the first rate is greater than the second rate.

7. The method of claim 5, wherein the signals sent to feed the color masterbatch thermoplastic polymer pellets or granules randomly alternate between the first rate being greater than the second rate and the second rate being greater than the first rate.

8. The method of claim 5, wherein the signals sent to feed the color masterbatch thermoplastic polymer pellets or granules randomly alternate between the first rate being zero and the second rate being non-zero.

9. A method comprising:
feeding thermoplastic polymer pellets or granules having one or more color pigments dispersed therein to an extruder from a first gravimetric feeder operatively connected to a computing device and adapted to receive signals from the computing device to control the amount of the thermoplastic polymer pellets or granules having one or more color pigments dispersed therein dispensed therefrom;
feeding non-colored thermoplastic polymer pellets or granules to the extruder from a second gravimetric feeder operatively connected to the computing device and adapted to receive signals from the computing device to control the amount of non-colored thermoplastic polymer pellets or granules dispensed therefrom;
feeding thermoplastic polymer pellets or granules having titanium dioxide dispersed therein to an extruder from a third gravimetric feeder operatively connected to a computing device and adapted to receive signals from the computing device to control the amount of the thermoplastic polymer pellets or granules having titanium dioxide dispersed therein dispensed therefrom;
wherein the computing device is adapted to send signals to the first and second gravimetric feeders to separately adjust the rates at which the first and second gravimetric feeders each feed the thermoplastic polymer pellets or granules having one or more color pigments dispersed therein and the non-colored thermoplastic polymer pellets or granules to the extruder; and
wherein the computing device is adapted to send signals to the third gravimetric feeder to adjust the rate at which the third gravimetric feeder feeds the thermoplastic polymer pellets or granules having titanium dioxide dispersed therein to the extruder such that an extrudate from the extruder contains sufficient titanium dioxide to deluster the extrudate.

10. A method comprising:
feeding thermoplastic polymer pellets or granules having one or more color pigments dispersed therein to an extruder from a first gravimetric feeder operatively connected to a computing device and adapted to receive signals from the computing device to control the amount of the thermoplastic polymer pellets or granules having one or more color pigments dispersed therein dispensed therefrom;
feeding non-colored thermoplastic polymer pellets or granules to the extruder from a second gravimetric feeder operatively connected to the computing device and adapted to receive signals from the computing device to control the amount of non-colored thermoplastic polymer pellets or granules dispensed therefrom;
selectively feeding thermoplastic polymer pellets or granules having a fire retardant composition dispersed therein to an extruder from a third gravimetric feeder operatively connected to a computing device and adapted to receive signals from the computing device to control the amount of the thermoplastic polymer pellets or granules having a fire retardant composition dispersed therein dispensed therefrom;
wherein the computing device is adapted to send signals to the first and second gravimetric feeders to separately adjust the rates at which the first and second gravimetric feeders each feed the thermoplastic polymer pellets or granules having one or more color pigments dispersed therein and the non-colored thermoplastic polymer pellets or granules to the extruder;
wherein the computing device is adapted to send signals to the third gravimetric feeder to separately adjust the rates at which the third gravimetric feeder feeds the thermoplastic polymer pellets or granules having a fire retardant composition dispersed therein to the extruder; and
wherein the third gravimetric feeder is periodically sent signals to feed the thermoplastic polymer pellets or granules having a fire retardant composition dispersed therein to the extruder and randomly sent signals to not feed the thermoplastic polymer pellets or granules having a fire retardant composition dispersed therein to the extruder.
